(19) United States
(12) Patent Application Publication
(10) Pub. No.: US 2010/0023162 A1
(43) Pub. Date: Jan. 28, 2010

(54) Method, System and Components for Operating a Fuel Distribution System with Unmanned Self-Service Gasoline Stations

(76) Inventors: Kristijan Gresak, Ljubljana (SI); Samo Omerzel, Novo Mesto (SI); Stelan Artnak, Smartno pri Litiji (SI)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/720,632

(22) PCT Filed: Dec. 8, 2004
(86) PCT No.: PCT/EP04/13980

§ 371 Date: Aug. 12, 2009

(51) Int. Cl. G06F 17/00; G06Q 10/00; G06Q 50/00; G06Q 20/00

(52) U.S. Cl. 700/241; 705/28; 705/8

(57) ABSTRACT

There are disclosed a method and a device for operating a fuel distribution system having a coordination center, unmanned self-service gasoline stations with fuel reservoirs and gasoline supply vehicles, the method comprising the steps of periodically determining the available amounts of remaining fuel in the fuel reservoirs; determining the present positions and fuel levels of supply vehicles; and generating an optimized delivery path for each of said supply vehicles on the basis of said determined available amounts of remaining fuel in the fuel reservoirs, said present positions and said fuel levels of said supply vehicles. Further there is provided an unmanned self-service gasoline station and a method for operation and a system.

The present invention relates to a new fuel distribution system with unmanned gasoline stations. It also relates to an automated system for optimizing the operation of a fuel distribution system. The present invention also pertains to a fully automated gasoline station.

Presently there are only gasoline stations known that enable a semi-automated fuel dispenser operation to provide a gasoline supply even during night time and even during the period of time when the averaged turnover of fuel does not even compensate the wage of a single worker.

At present there are only gasoline dispensers available enabling a gasoline delivery for cash or for electronic payment systems such as e.g. prepaid gasoline cards.

Different payment systems are actually available. The present invention also relates to a cashless payment system as e.g. disclosed in the International Patent Application WO 02/33669 A1.

With the present systems an unmanned 24 hours operation is not possible, as customers also demand additional purchase goods and items such as beverages, food, oil, water, air, windshield cleaning fluid, break fluid, newspapers, and journals. Actually it is not possible to satisfy these multiple customer demands with only a single automated fuel dispenser.

It is desirable to reduce the operational costs of filling stations. It is further desirable to increase the unmanned service time to up to 24 hours a day and 7 days a week operation which is a so-called 24/7 operation. With the presently available gasoline delivery systems such a 24/7 service is only achievable with shift work. It is also desirable to extend the 24 hours a day, 7-days per week operating service without any personnel to different and other service offers than just gasoline distribution.

It is also desirable to have an optimized architectural design of unmanned gasoline stations using advanced technology for the operation.

According to a first aspect of the present invention a method for operating a fuel distribution system with a coordination center, unmanned self-service gasoline stations and fuel reservoirs and gasoline supply vehicles is provided. The operating method for a fuel distribution system comprises the steps of: periodically determining the presently available amount of remaining fuel in the fuel reservoirs; determining the actual positions and fuel levels or fuel states of supply vehicles, and generating optimized delivery paths for each of said supply vehicles on the basis of said determined amount of fuel in the fuel reservoirs, said positions and fuel levels of said supply vehicles.

By periodically determining the available amount of fuel in the fuel reservoirs the fuel levels in the unmanned gasoline stations, said payload containers and the tanks of gasoline supply vehicles, fuel reservoirs of tank farms can easily be determined and made available for further processing.

This measurement can be performed in a time-controlled manner at least once a week, once a day, once an hour, or once within a range of minutes. It is also possible to determine the present amount of fuel in the reservoir in an event-controlled manner: e.g. each time a user or consumer wants to start to draw gasoline form a reservoir. The determination can also be performed after each tank filling process. A combination of these tank reservoir surveillance procedures may be best suited for the overall operation. The surveillance of the present amount of fuel in the reservoir enables a kind of double entry bookkeeping of the fuel streams.

When the tank volume is permanently surveyed, any possible shrinkage may be determined and any kind of reason for this shrinkage may also be determined and removed, by determining the actual positions and present fuel levels (payload fuel levels and gasoline levels in the operational tanks) or filling states of supply vehicles i.e. tank vehicles, and generating optimized delivery paths for each of said supply vehicles on the basis of said determined amount of fuel in the fuel reservoirs and said positions and fuel levels of said supply vehicles.

The fuel levels of the supply vehicles comprise payload fuel levels (mogas, avgas, two-star and four-star petrol/regular/premium gasoline/diesel/heating oil/fuel oil) and internal petrol fuelstate (to determine the actual operation range).

The classic objective of supply chain management is the ability to provide the right products in the right quantities at the right place at the right moment at minimal cost. To achieve this objective a wide range of processes have to be managed procurement, inventory management, demand planning/forecasting, warehouse management, logistics, transportation planning, delivery scheduling, and delivery management. The present invention strives to provide application program suite addressing the issues of oil & gas distribution with detailed solutions, tailored to the specific needs of a petrol supply chain.

The supply chain extensively supports supply chain collaboration and enables oil companies to build an extended partner network with its supply chain partners. With latest technologies like XML, SOAP and Web Services, as well as powerful support for enterprise application integration, the technology of the present invention enables efficient wholesale and retail cooperation.

With the invention a coordination center is enabled to monitor the fuel inventory, the vending machines stock inventory, a control of gasoline station equipment, payment supervision, and monitor environmental parameters. It is also envisaged to monitor and control of fire protection and extinguishing equipment, equipment configuration and upgrading, price pole configuration and video surveillance are all provided remotely using a site management system. This highly capable system is using a commander server as a hub to reliably transfer data to and from the gasoline station.

It is also envisaged to use autonomous or semi-autonomous fire protection and extinguishing equipment, to ensure quick and safe operation of the fire protection and extinguishing equipment even in case of a communication failure, a power failure, or even a water supply failure. This system can also provide other alarm monitoring and notifying features.

For example it is possible to record current inventory status, and use historical data for various trend analysis, inventory reconciliation, sales, booked and measured deliveries, event and alarm statuses, etc. The information may be made available and be processed in various forms, charts and reports, from basic single-tank inventory views to sophisticated and aggregated views according to organizational structure. These features offer a broad range of possibilities for analyzing the critical information and track the key performance indicators like the inventory carrying costs, number of run-outs, average fuel/water height, present delivery statuses, etc.

In an example embodiment said determining of the present amount of fuel in the fuel reservoirs further comprises transferring said determined available present amounts of fuel in the fuel reservoirs to a coordination center periodically. This transfer can be performed via proprietary communication connections from a gasoline station, said supply vehicles or to said tank farms or to said coordination center.

That is, the present fuel levels of the vessels of the tank farms, the present fuel levels in the payload vessels of fuel supply tanks and the storage tanks of the gasoline stations are transferred periodically to the coordination center. Thereby the coordination center is enabled to collect fuel level data, determine the paths of fuel distribution and other significant correlations in the fuel paths. Additionally it is possible to determine the purchase behavior of single customers. This may enable the use and optimization of storage tanks with different tank volumes for the different kinds of fuel (diesel, regular, and premium gasoline).

In case of the fuel levels of the gasoline stations this transfer may also be performed in connection with a payment data exchange during e.g. a user provided telephone connection to a payment center (M-pay). Customer and user data and any kind of present fuel levels of the tanks, can also be transferred to the coordination center by an onboard message transmission system (In case of the customers e.g. by an onboard mobile phone and in case of supply vehicle drivers by a communication system).

In another example embodiment of the present invention said method further comprises periodically storing said periodically determined available present amounts of fuel. This storing can be performed at the tank farm, said supply vehicles and/or said gasoline stations, before this data is transferred to said coordination center. It is also envisaged to store said periodically determined available present amounts of fuel at the coordination center.

With these stored data the coordination center can generate an actual demand profile for each gasoline station and can determine the most effective gasoline supply path for all supply vehicles.

With these stored data the coordination center can purposefully search for any correlations and structures in the stored data basis. With an extensive data basis the fuel demand of each gasoline station may become predictable (within limits), which in turn enables the coordination center to optimize the gasoline storage and delivery procedures.

In another example embodiment of the present invention said method further comprises: determining a user identification, performing an authentication procedure, dispensing fuel, measuring the value of dispensed fuel quantity, and transferring payment data comprising said user identification and said fuel quantity to a payment center, wherein said determined available amounts of fuel are transferred together with said payment data.

In case the coordination center also provides payment tasks e.g. each usage of the M-pay payment procedure may be used to transfer, in addition to the actual customer data and the amount of dispensed fuel, also the present fuel levels of the tanks and/or other operational parameters of the petrol station via acoustic modems and customer owned mobile telephones. It is clear that provisions are to be taken to enable the setup of a message or surveillance connection in case of e.g. an emergency.

In another example embodiment said method further comprises transferring said generated optimized delivery path to said supply vehicles. It is envisaged that the optimized delivery paths are transferred from the coordination center only to those vehicles that are actually “on duty”. The coordination center can also determine the ideal number of supply vehicles for a most cost efficient operation of the system of self-service gasoline stations, supply vehicles, (tank farms) and coordination centers during the operation of the system. It is also possible to determine the most ideal point in time for a service or refilling operation of the gasoline stations.

The coordination center can transfer said generated optimized delivery path to said supply vehicles by sending short messages to e.g. vehicle onboard units or to mobile phones. Messages can be sent to the supply vehicle or the driver, individual groups or the whole vehicle fleet. All messages can be stored and can be made available for future review.

According to another example embodiment of the present invention said method further comprises generating optimized delivery paths for each possible combination of filling state, of fuel reservoirs, supply vehicles fuel levels, supply vehicle positions and fuel levels of said supply vehicles. Thereby the coordination center can pre-calculate all possible ideal routes for each supply vehicle, with the assumption that all vehicles are actually in the garage and empty, to optimize a delivery path for different situations of fuel requirement of a number of gasoline stations with different fuel levels in the fuel reservoirs. This example embodiment my be interpreted as the “brute force” solution for the “travelling salesman” problem, for a number of salesmen (or better supply vehicles). The system may rely on a set of starting information that can be specified and refined during operation, as the system in operation acquires a broader database for optimizing the delivery paths. That is, a computer system in the coordination center can autonomously determine optimized delivery paths for different fuel level scenarios of a set of unmanned self-service gasoline stations. The system may use different optimization parameters, such as fastest, most efficient and/or cheapest delivery paths for the supply vehicles. It may be one optimization parameter to provide a fastest refilling of a gasoline station, or a distance optimized delivery path or even a time optimized delivery path for a number of gasoline supply vehicles.

According to another aspect of the present invention a method for operating an unmanned self-service gasoline station is provided. The method comprises periodically determining the present amount of fuel in the fuel reservoirs; monitoring and controlling of gasoline or fuel dispensers, and performing payment procedures for dispensed gasoline. The method further comprises monitoring and controlling of fire protection and extinguishing equipment, monitoring alarm sensors, video monitoring, remote equipment configuring and remote price pole configuring.

The monitoring of fuel levels, the proper operation of all systems, emergency system control, surveillance and all other functions are monitored and operated remotely.

By periodically determining the present amount of fuel in the fuel reservoirs, e.g. of tank gauging equipment, the data of said at least one gasoline station or central fuel storage are made available. The fuel (diesel, regular and premium gasoline) can be monitored at least once a week, once a day, once an hour or once within a minute range (time controlled). It is also envisaged to determine the present amount of fuel in the reservoir in an event controlled manner: e.g. each time a consumer want to start or starts a gasoline drawing form the reservoir. The determination can also be performed after each tank filling process. A combination of these tank reservoir surveillance procedures may be best suited for the overall operation of a self-service gasoline station. The surveillance of the present amount of fuel in the reservoir enables a kind of “double entry bookkeeping” of the fuel levels and allows monitoring the fuel streams. When the tank volume is permanently surveyed, any possible shrinkage may be determined and any kind of reason for this shrinkage may also be determined and removed.

The method for operating the self-service gasoline station can also provide a payment procedure. This payment procedure may be based on a “pre-paid” or “post-paid” service. As many users of a self-service gasoline station often change their mind during the tanking or refueling procedure it is required to offer a flexible system to allow drawing different amounts of fuel. It is envisaged to allow a user to draw fix amounts of fuel or fuel corresponding to a fixed amount of money, or to allow for filling up a car's tank with an arbitrary amount of fuel. It is also contemplated to implement a system using a predetermination of an available refueling volume. By using e.g. sound (and maybe also temperature) measurements a “present refueling volume” of a vehicle tank can be determined to “predetermine” and indicate an approximate amount of fuel that can be filled into a tank. It may also be possible to implement special buttons for 5, 10 15, 20 . . . 100 liters or e.g. 5, 10 . . . currency units. This would satisfy the needs of people filling in “10/20 liters” or fuel corresponding to “10/20ε/Bucks” and/or “filling up”.

By automatically monitoring of the fuel inventory, vending machines stock inventory, controlling of gasoline station equipment, payment supervision, monitoring of environmental parameters, monitoring and control of fire protection and extinguishing equipment, monitoring equipment configuration and upgrading, price pole configuration and video surveillance, all key features for operating a gasoline station can be provided remotely from the coordination center using a gasoline station management system. The gasoline station management system can use a commander server as a hub to reliably transfer data to and from the coordination center. This system can also provide alarm monitoring and notifying.

The method further comprises monitoring and controlling of fire protection and extinguishing equipment, monitoring alarm sensors, video monitoring, remote equipment configuring and upgrading and remote price pole configuring.

According to another aspect of the present invention a computer program product downloadable from a server for carrying out the method of the preceding description is provided, which comprises program code means for performing all of the steps of the preceding methods when said program is run on a computer or a network device.

According to yet another aspect of the invention, a computer program product is provided comprising program code means stored on a computer readable medium for carrying out the methods of the preceding description, when said program product is run on a computer or a network device.

According to another aspect of the present invention an unmanned self-service gasoline station is provided. The gasoline station of the present invention comprises at least one fuel reservoir, being provided with a fuel gauge, said fuel reservoir being placed in a fuel-tight trough. The gasoline station further comprises at least one fuel dispenser for each of said fuel reservoirs and at least one platform for each fuel dispenser provided with a catch element and provided with oil traps and at least one canopy element covering at least the area of each said platform and said trough. In the following the expression “fuel dispenser” is used for any kind of fuel dispensing devices such as gasoline dispensers, petrol pumps or gasoline pumps. The at least one fuel reservoir of the gasoline station is an above-ground storage fuel reservoir and all key components are standardized and modular.

The gasoline station of the present invention further comprises an automated tank gauging system, in said fuel reservoir, payment terminals using payment cards and mobile phones, at least one remotely configurable price pole, and at least one data exchange interface.

Each fuel reservoir of said self-service gasoline station is provided with a fuel gauge, and said at least one fuel reservoir is placed in a fuel-tight trough. The fuel-tight trough can be a completely sealed trough to prevent that e.g. cleaning fluids, rain or precipitation may fill the overflow trough with undesired water. The tank can be made of composite material, plastics, elastomer material, steel or aluminum and the trough can be made of steel aluminum, steel, concrete or reinforced concrete.

A basic core of the gasoline station can serve as the room for the fuel tank(s). The tanks can be placed in reinforced concrete water-tight models, having e.g. the dimensions of 2.50 m×2.60 m+1.60 m×2.58 m, that are interconnected and sealed. Dispensing points and individual vending machines can be located along the sides of the models. Each side of the gasoline station can be provided with two dispensing points with triple (or quadruple) filling pipes and a tank-filling device.

The gasoline station further comprises at least one fuel dispenser for each of said fuel reservoirs, i.e. the gasoline station comprises at least one fuel dispenser.

The gasoline station is provided with at least one refueling platform for each fuel dispenser, wherein said platform is provided with catch elements and oil traps

According to the invention the platform of a dispensing point can be made of pre-fabricated AB plates that are dilatation-interconnected and sealed. The surface treatment of the platform can be embodied as an anti-slip cement coating, slanted towards an outer or inner watertight conduit. An edge between the platform and the dispensers can be raised and protected.

At least one canopy element is covering at least the area of each said platform and said trough.

Atmospheric and surface water falling on the platform are collected in a watertight conduit and led through the oil trap and into the drain, as prescribed by the location prerequisite. The oil trap can be a standardized one. However, it must comply with the prescribed capacity. It is also possible to implement the oil trap as a part of the gasoline station. In this case a perspective reservoir is to be provided for the oil trap. The roof may be designed to cover a wider area than just the platform, to reduce the necessary volume of the oil trap of the platform.

Above the central part of the tank and the dispensing points there can be provided an arc-shaped prefabricated metal roof. The basic construction may consist of steel frames spaced at 2.50 m with intermediary connections and a stretching element. The roof covering can be combined with light aluminum sheet metal and transparent “leksan” roof covering. The roof can be suspended by a support structure comprising masts. Between the masts of the roof construction there can be provided advertisement elements.

The at least one fuel reservoir of the gasoline station is an above-ground storage fuel reservoir. In addition to the above-ground fuel reservoir all components that have been conventionally placed underground, such a tanks cellars or basement constructions, can be economized. Above-ground means that all main elements of the gasoline station are located above-ground level. This enables a significant increase in the speed of construction and a step forward from the viewpoint of ecology. The only prerequisite for erection of a gasoline station is an AB base plate, equipped with suitable traps for oil and other dirt.

With this design the gasoline station can be disassembled, moved and can be reassembled at another location in a relatively simple way, and in relatively short time. It is no longer necessary to demolish the gasoline stations of the present invention.

The gasoline station of the present invention is also standardized and modular in all key components. That is, said at least one fuel reservoir, said fuel-tight trough, said at least one fuel dispenser said at least one refueling platform and said at least one canopy or roof element are standardized and comprise at least standardized connection interface. It is also contemplated to combine e.g. differently designed canopy elements or platform elements of different width, which is possible as long as the connection interfaces to the trough element is the same.

As all key system components are modular and provided with standardized connection elements. That is the gasoline station according to the present invention is scalable with respect to the size of the gasoline station and can be disassembled. It is for example envisaged to make it possible to extend a gasoline station by adding additional trough elements, tanks, canopy elements, platforms and fuel dispensers. That is, the length of the one-row or one-trough gasoline station can be extended arbitrarily. It is also envisaged to use modular trough/tank elements that can directly be coupled together in parallel. In this case the trough would be a kind of tandem or double trough doubling the gasoline storage capacity while increasing the width of the gasoline station by the width of one trough. Thereby the gasoline capacity can be increased with a double, triple or quadruple trough without any necessity to increase the length of the gasoline station. It is also envisaged to use platform and canopy elements that can be connected to two trough elements. The thereby parallel one-row gasoline stations can be interconnected to form a wide gasoline station with an arbitrary number of possible fuel dispensers.

With the present invention it is possible to use an arbitrary number of fuel dispensers, build up any desired arrangement of fuel reservoirs and fuel dispensers, with a unit construction system.

It is also possible to harmonize the appearance of the gasoline station with the local architectural characteristics by employing respective specially designed canopy and trough elements.

Due to the above-ground construction and the modular system the unmanned self-service gasoline is designed to be built and erected in the shortest possible time. The modular construction enables mass production. A typified modular construction made of prefabricated parts enables adaptation to individual locations and provides simple upgrading. The appearance of the gasoline stations can visually be completely changed with minimal modifications to conform to local urban regulations. The design can be implemented environmental friendly and can fulfill all required safety regulations. The trough can provide superior impact resistance, which in connection with the above-ground construction may enable the whole gasoline station to make way in kind of slipping movement as known e.g. from a slipper break. It is also envisaged to provide crash barriers and guide rails at the platform and at the trough elements. It is also envisaged to employ diverters to guide a vehicle crashing into the trough away from the tank element.

The provided gasoline station is innovatively designed, fully automated, operable without personnel and can significantly reduce the costs of operation on the basis of successful operation of a 24 hour 7 days a week system.

All systems of the gasoline station can be fully automated, so that the presence of personnel taking care of sales and supervision of the gasoline station is not necessary at the gasoline stations during the time of operation. Payments are carried out using state-of-the-art payment terminals, enabling payment of fuel with payment cards and mobile phones. Monitoring of the key system parameters and alarms at the gasoline stations can be performed by a remote monitoring system. For example the monitoring of fuel levels, fuel dispensers and payments as well as the proper operation of all systems, emergency system control, surveillance and all other functions can be monitored and operated remotely. The remote monitoring can be provided via said at least one data exchange interface.

The gasoline station is user friendly as the customers can carry out all the necessary procedures at the gasoline station in a quick and simple manner and fuel payment is provided to customers using payment cards or mobile phones. Users also profit from non-stop operation representing a big step forward in satisfying the customers needs as all services are available to customers 24 hours a day, 7 days a week.

This also included that conventional customer/user needs are to be satisfied too, including six-packs, cigarettes, sweets/candy, deep freeze pizzas, sandwiches, newspapers, magazines, tire pressure control devices, coffee makers, lavatories and the like. It is to be noted that all these components have to be violence proof, automated and remotly diagnosable.

The present invention provides low investment costs as the components of the unmanned gasoline station can built in series production, reducing the construction costs of the gasoline station significantly below the ones of a conventional gasoline/service station. A consequence is, of course, a low profitability threshold of the investment and the ability to reach the break-even point earlier. The costs for operating an unmanned gasoline station are compared to a classic gasoline station, lower for at least for the amount of the labor costs. Low maintenance costs due to remote monitoring guarantees a reduction of the fixed maintenance costs, as on site personnel is only necessary if a cause for maintenance is detected by the remote surveillance. The present system does not only provide the possibility to move the gasoline station personnel to a coordination or surveillance center, but also enables a single person to survey a number of gasoline stations, effectively reducing the surveillance employees to ±½, ⅓ or ¼ per gasoline station.

This remote operability of the fuel dispensers is achieved by an automated tank gauging (ATG) system that provides extremely accurate local and remote wet-stock control over multiple sites. This system is the basis of the supply chain management and as such the basis of the successful operation of the whole system.

The system employs a high-resolution tank probe for measuring fuel level, water level and fuel temperature in underground and above-ground storage tanks. A rod shaped probe can measure different kinds of fuels, including gasoline, diesel, heating oil and aviation fuel.

The tank level gauge can support tank probes, leakage sensors and level switches. Tank probe responses can be constantly analyzed by an algorithm, detect dirt, possible measurement noise and other anomalies, which in conjunction with e.g. a segmented capacitive principle of the tank probes provides an unsurpassed accuracy of the measurements.

The gasoline station is provided with a commander server as on-site controller specifically designed for local and remote site management, site monitoring and control. It integrates different measuring systems and control devices like automated tank gauges, fuel dispensers, POS (Point Of Sale) terminals (vending machines) and payment systems into a single, highly effective system. Due to the modular design the commander can be adapted to any configuration of gasoline stations or terminals. It offers various solutions for POS and BOS (Back Office) connectivity, making possible sales analysis, delivery variance analysis and, most importantly, business inventory reconciliation (BIR). The server is provided with a data exchange interface to a communication network for connecting it to a coordination center. It is also envisaged that the commander server can use any TCP/IP supporting communication path for the communication with the coordination center. It is also envisaged that the connections between the coordination center and the commander servers of the gasoline stations use a proprietary communication connection and/or a proprietary communication protocol.

In an example embodiment of the present invention said above-ground storage fuel reservoir is arranged in a concrete trough. The trough serves as a gasoline catch vessel to prevent environmental contamination in case of leakage of the tank reservoir. Additionally, the through can provide an impact protection against vehicles crashing into said unmanned gasoline station. Due to the construction of a compact gasoline station with no direct rigid fundamental connection the whole gasoline station may absorb a part of the momentum of the impacting vehicle.

In another example embodiment of the present invention said payment terminals for mobile phones are M-payment system terminals. The M-payment system is a payment terminal system using voice frequency band transfer via a user-owned mobile phone to transfer authorization data to an authorization center or payment center. The M-payment system does not need any active networking equipment such as a GSM modem or a dedicated wireless network thus making it independent from network operators. In the M-payment system a user owned mobile phone is used to transfer data, which radically simplifies terminal design and enables to specialize the terminal for safe and reliable payment authorization. M-payment is a mobile payment system enabling a mobile phone to become a payment instrument on its own.

M-payment represents a reuse of acoustic modems in the world of digital mobile communication via customer owned mobile telephones. Due to the use of acoustic modems the data transfer is network and network operator independent as, acoustic modems operate in the frequency band of the human voice which can be transferred with all known mobile (e.g. GSM/GPRS/UMTS terminals).

The M-payment system is fast and simple, as it requires only one call to complete a transaction. This payment system is also reliable, as advanced techniques are used to make the system work under all conditions. The system is safe as e.g. elliptic curve cryptography can be used to protect from fraud. And the M-payment system is cheap and uses the latest developments in DSP (digital signal processing) technology to achieve by far the best price/performance ratio on the market.

Yet another example embodiment of the present invention is provided with vending machines connected to said payment terminals enabling single payment operation for said fuel dispensers and said vending machines. The vending machines can also be provided with independent payment terminals to enable the purchase of vending machine content without the necessity to draw fuel. An interconnection of the vending machines with the payment system of the fuel dispensers reduces the necessity to perform different payment procedures when purchasing gasoline and other goods.

The M-payment system has also the advantage that there is no need for currency storage devices and change devices. The cashless implementation also reduces the risk of vandalism and break open attempts. It may be possible to implement a single cash operated voucher card dispenser to enable a cash payment even for persons without a mobile phone or a car phone.

It is also possible to provide air pumps to enable a user to check and change its tire pressure. The self-service gasoline station may also be provided with devices (e.g. a bucket, a sponge and a wiper) for cleaning e.g. windscreens.

In another example embodiment said unmanned self-service gasoline station is further provided with an automated fire alarm and extinguishing system. It is also contemplated to provide e.g. a CO₂ fire extinguishing equipment, a sand fire extinguishing equipment or a foam fire extinguishing equipment at the gasoline station. It is also envisaged to provide a call box in the unmanned self-service gasoline station. It is also contemplated to provide an emergency phone that may be mounted in a pillar of the unmanned gasoline station.

It is also envisaged to use autonomous or semi-autonomous fire protection and extinguishing equipment, to ensure quick and safe operation of the fire protection and extinguishing equipment even in case of a communication failure, a power failure, or even a water supply failure. The autonomous fire protection and extinguishing equipment can be connected to a coordination center and/or be directly connected to the next fire department. It may be necessary to provide the gasoline station with an independent power supply and an independent fire extinguishing material reservoir.

By the communication connection any kind of information. e.g. related to the amount of gasoline in the tanks and the approximate number of fire fighting appliances, special fire fighting appliances and required firefighters required may be transferred to the fire department.

In another example embodiment of the present invention said at least one canopy element is provided with solar collectors for operation of said fuel dispensers. The gasoline station may also be provided with a wind-powered generator for providing energy for the fuel dispensers. A gasoline-powered generator may be supplied to ensure autonomous operation. The gasoline station may also be supplied with a cistern to provide water “not for drinking’. The gasoline station may also be supplied with a vessel for waste water. Thereby the requirements for any kind of infrastructure can be significantly reduced. That is, it may be possible to operate the gasoline station completely autonomously, without any connection to an electrical supply network, water supply and/or sewers.

In another example embodiment of the present invention said unmanned self-service gasoline station is further provided with an automated lavatory. This lavatory can be embodied as a privy or as a fully automated self-cleaning lavatory such as e.g. known from the capital of France.

In another example embodiment of the present invention said unmanned self-service gasoline station is provided with a chassis connected to said fuel-tight trough and/or said fuel reservoir. In this case said refueling platforms and said canopy element are foldable. This embodiment represents a kind of mobile gasoline self-service station for automobiles. This mobile gasoline station may be embodied as a fuel-tank trailer with foldable platforms and canopies and built-in payment stations and fuel dispensers. The canopies may be made of sailcloth or canvas. It is also possible to implement the mobile gasoline station in a kind of self-propelled gasoline station. It may e.g. be possible to use such temporary gasoline stations for highway car parks to ensure e.g. a fuel supply even during surges of holiday traffic. It is also contemplated to use such a mobile self-service gasoline stations to determine the attractiveness (for the company and for users) of a location or a site before building a new unmanned gasoline station. It is e.g. possible to place a mobile gasoline station along temporal route diversions. This solution can be operated without any supply vehicles, as the whole mobile gasoline station may be exchanged and be replaced by a new one.

In another example embodiment of said unmanned self-service gasoline station, said automated tank gauging system is provided with a probe for fuel level, water level, pollution and soiling detection measurement in said fuel reservoirs. It is also envisaged to provide a temperature probe in said fuel reservoir. It is contemplated to implement a viscosity probe in said fuel reservoir.

It is possible to provide for each measurement task a single probe. With these data a complete surveillance of the operation of an unmanned self-service gasoline station can be provided. It is also envisaged to employ combination measurement probes for measuring different parameters with a single probe e.g. a level probe that can also determine the temperature in the fuel reservoir. It may also be contemplated to use a probe capable of determining the density and the temperature of the contents of a fuel reservoir. It is possible to implement a measurement system to determine e.g. the velocity of sound of the fuel in the fuel reservoir. It is also contemplated to employ a probe for determining a (light) transmission coefficient of the fuel in the fuel reservoir. These measurements can be used to determine if the content in a fuel reservoir actually matches the intended content. These measurements can be used to prevent that e.g. diesel oil mistakenly filled into a gasoline tank is actually dispensed via a gasoline dispenser.

Yet another example embodiment of said unmanned self-service gasoline station is provided with a segmented, high-resolution, solid state based capacitive measurement probe, for fuel level measurement, water level measurement, temperature measurement and pollution or soiling detection.

In yet another example embodiment of the present invention said refueling platform is provided with an elastic surface layer. Elastic surface layers are known from e.g. “tartan tracks” of sport stadiums. The elastic surface layer can be provided to prevent that mobile phones may cause sparks resulting from short circuited batteries of falling mobile phones hitting the platform in the vicinity of the fuel dispensers.

According to another aspect of the present invention a supply vehicle for an unmanned self-service gasoline station is provided. The supply vehicle comprises a tank section for at least one kind of fuel. The supply vehicle is further provided with a tank gauge, a positioning system and a communication device for communicating with a coordination center. The positioning system is provided for transmitting the present position of the supply vehicle to a coordination center. The tank gauges are provided to determine the present content of the operational fuel tank and the payload gasoline tanks, and to provide this data to the coordination center. That is, the present invention provides means to keep a coordination center informed about the present position, payload, and range

The communication device can be configured to indicate to a driver of a service vehicle the best route to a tank farm, to a gasoline station, a storage or the next gasoline station.

Starting from automated gasoline stations the human controlled and remotely surveyed supply vehicle represents another (partly automated and remotely controlled) entity in a system for operating automated unmanned gasoline stations.

The supply vehicle of the present invention can provide optimal fuel distribution to every gasoline station with minimal operator involvement, eliminating run-outs, providing demand planning, and optimal transportation planning and delivery management. The main merit resides in the fact that the system can always access all positions and fuel levels of all supply vehicles, and can coordinate the routes of all supply vehicles in an optimized way. It is also possible to implement restrictive elements for limiting the driving times of the driver of the supply vehicles according to local regulations.

In an example embodiment of the invention said supply vehicle is further provided with a vending machine goods container, floodlights, cleaning installation and lavatory maintenance devices. To reduce the number of necessary maintenance visits the supply vehicle can be provided with a goods container and e.g. a food-container for refilling the vending machines of the gasoline station. It is also envisaged to provide cleaning devices such as an oiltrap cleaner or a hot water/steam cleaner installation for cleaning the above-ground surfaces of the unmanned gasoline station. It is also envisaged to provide devices to maintain an automated lavatory. To enable a nighttime operation it is contemplated to implement a floodlight system in the supply vehicle to enable nighttime cleaning operations.

According to another aspect of the present invention a coordination center is provided, having a communication system for communicating with gasoline stations, supply vehicles and fuel reservoirs. The coordination center is provided to periodically or permanently receive and evaluate information related to the state of the system. The coordination center is calculating the optimized routes for all supply vehicle on the basis of the gasoline volumes in all fuel reservoirs of the gasoline stations and the supply vehicles.

According to still another aspect of the invention a fuel distribution system with unmanned self-service gasoline stations as disclosed in the preceding specification, supply vehicles as disclosed above and a coordination center is provided. The advanced technology can allow to operate the whole system optimally with minimal personnel requirements and low operational costs. There is different equipment present in the gasoline station that can be remotely operated. The fuel payment system is supporting payment with regular payment cards and mobile phones. A tank level measurement system is the basis of the supply chain management, which is complemented by a fleet management system. The equipment of the gasoline stations also includes regular gasoline station equipment (tanks, dispensers, fire fighting equipment) and a site management system, enabling unmanned and uninterrupted operation.

Automated tank gauging (ATG) systems in the gasoline stations and supply vehicles provide permanently ans extremely accurate local and remote wet stock control over multiple gasoline stations. This system is the basis of the supply chain management and as such the basis of the successful operation of the whole system. The ATG system can be temperature compensated. The system is applicable for kinds of gasoline stations or service stations for all kind of fuels, including gasoline, diesel, raps oil, heating oil, hydrogen, natural gas and/or aviation fuel.

The classic objective of supply chain management is the ability to provide the right products in the right quantities at the right place at the right moment at minimal cost. To achieve this objective a wide range of processes have to be managed: procurement, inventory management, demand planning/forecasting, warehouse management, logistics, transportation planning, delivery scheduling, and delivery management. The present system can use technologies like XML, SOAP and Web Services, as well as powerful support for enterprise application integration.

Advanced technology is making the whole system work at optimal efficiency and provides the best quality of service to the customers.

In the following, the invention will be described in detail by referring to the enclosed drawings in which:

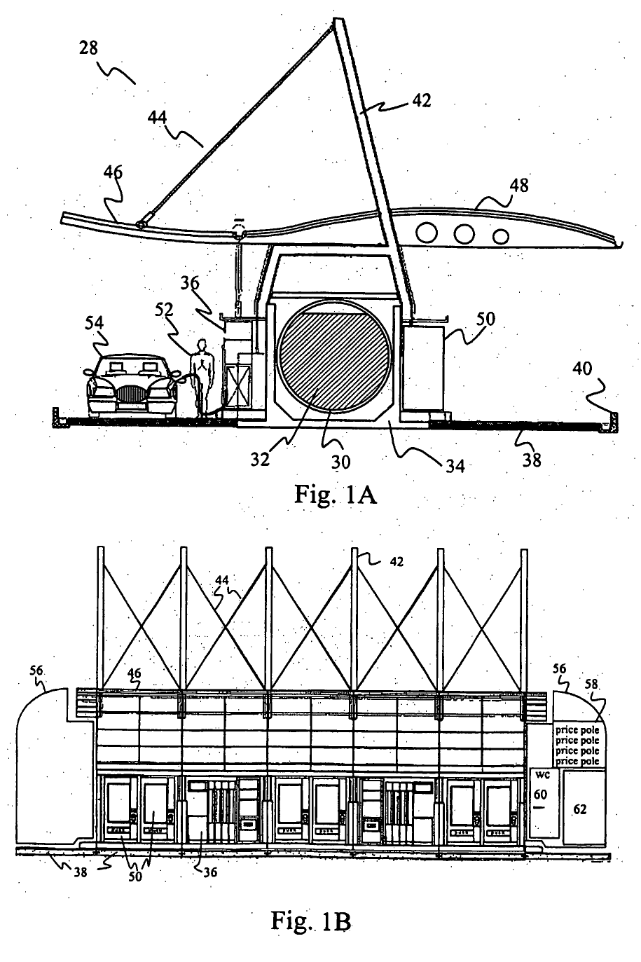

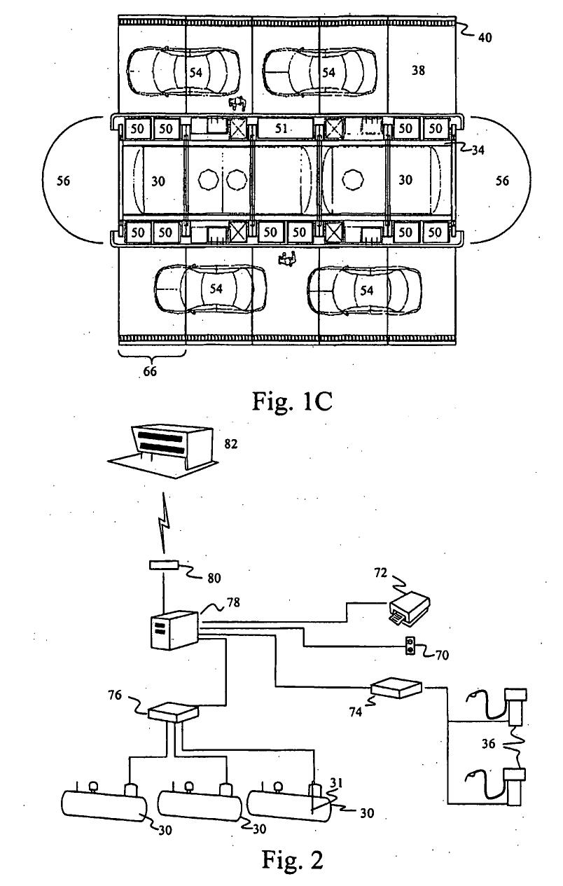

FIGS. 1A to 1C are plan drawings of an unmanned gasoline station according to one aspect of the present invention,

FIG. 2 is a schematic view of the coordination center and the connection to the unmanned gasoline station,

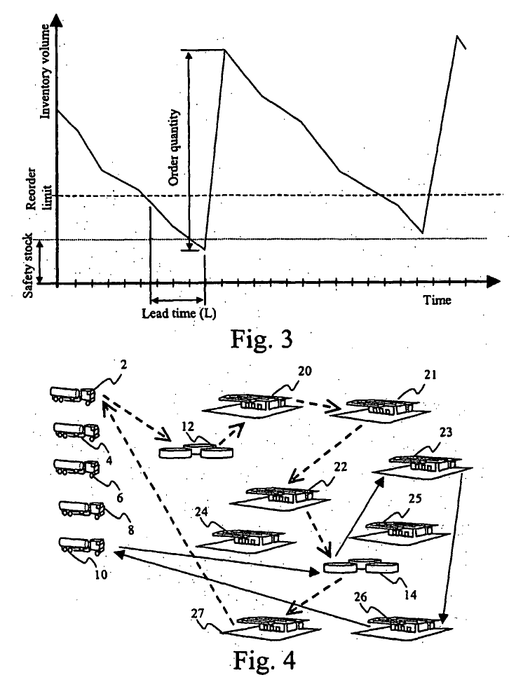

FIG. 3 depicts a graph visualizing the connection between the tank gauge signals and the transmission of a reorder/refuel signal, and

FIG. 4 graphically visualizes the optimization problem of the coordination center.

In the detailed description that follows, identical components have been given the same reference numerals, regardless of whether they are shown in different embodiments of the present invention. In order to clearly and concisely illustrate the present invention, the drawings may not necessarily be to scale and certain features may be shown in somewhat schematic form.

FIG. 1A is cross sectional view of an unmanned gasoline station according to one aspect of the present invention. FIG. 1B is a longitudinal view of the unmanned gasoline station of FIG. 1A. FIG. 1C is a cross sectional top view of the of the unmanned gasoline station of FIGS. 1A and 1B. The basic core trough 34 of the gasoline or service station 28 serves as the room for the fuel tank 30. The tanks are placed in reinforced concrete watertight troughs or models 34, with the dimensions of 2.50 m×2.60 m and 1.60 n×2.58 m, that are interconnected and sealed. Dispensing points, i.e. fuel dispensers 36 and individual vending machines 50 are located along the sides of the models 34. On each side of the gasoline station 28 two dispensing points 36 with e.g. triple filling pipes and a tank-filling device 51 are arranged.

Above the central part of the tank 30 and the dispensing points 36 there is an arc-shaped prefabricated metal roof 44, 46 and 48. In the figure the basic construction consists of steel or aluminum frames spaced at 2.50 m with intermediary connections and a stretching element 44. The roof covering is combined with light aluminum sheet metal and transparent “leksan” roof covering. Between the “masts” 42 of roof construction there is room for advertisements.

To the left of the axis of the central object there is a box 51 used for installation of technological equipment. The platforms 38 are made of pre-fabricated plates that are dilatation-interconnected and sealed. The surface treatment of the platform is an anti-slip cement coating, slanted towards the outer watertight conduit 40. The edge between the platform and the dispensers is raised and protected.

The gasoline station can be equipped with special machine installations for gasoline stations and with electrical installations. The gasoline station can be adapted to individually selected locations and corresponding location prerequisites.

The canalization/draining of wastewater can be ensured in two individual ways: 1. Atmospheric precipitation is lead from the roof through a collecting gutter at the end and in the intermediate part of the roof into a seepage reservoir or the canalization, depending on the location prerequisite. 2. Atmospheric and surface waters of platform are collected in a watertight conduit and led through an oil trap (not depicted) into the drain, as prescribed by the location prerequisite. The oil trap can be a standardized one. However, it must comply with the prescribed capacity.

The exterior arrangement may be adapted to the requirements of individual locations with regard to road connections and traffic regime, as well as the general arrangement. Exterior lighting, signalisation and advertising equipment will also be provided in scope of a location. The architectural design of a gasoline station emphasizes a novel styling approach of such objects that can be completed in reasonable arrangement of the selected location. It is envisaged to create an architectural recognizability with the architectural design a certain function or a certain gasoline company.

The equipment for the gasoline stations 28 includes regular gasoline station equipment tanks 30, fuel dispensers or dispensers 36, fire fighting equipment and additional equipment, enabling unmanned and uninterrupted operation.

The automated gasoline station comprises a fuel storage room i.e. a tank 30 and fuel dispensers 36 and supplying devices 50, 51 arranged around it. All the installations used to supply and dispense fuel are placed in the area around the tank.

The basic construction and element design is identical in every case, only the sub-construction with foundation and the location of connections and utility services change.

In FIGS. 1A and 1C the are vehicles 54 and humanoid shapes 52 depicted to visualize the size of the gasoline station. In FIG. 1B there are end elements 56 depicted that can serve for accommodating extra devices such as e.g. price poles 58, a lavatory 60, advertisement element 62 or even crash elements (not depicted). The end elements there can also accommodate communication installations, fire equipment and the like.

FIG. 2 is a schematic view of the coordination center and the connection to the unmanned gasoline station. The headquarter or coordination center 82 is provided for
monitoring and control of tank gauging equipment 31 of the tanks of the gasoline station 28,
monitoring and control of dispensers,
monitoring and control of fire protection and extinguishing equipment,
alarm monitoring,
video monitoring,
remote equipment configuration and upgrading, and
remote price pole configuration.

The coordination center is connected to the gasoline station via e.g. an ISDN connection and a router or a modem 80 to a commander server 78 of the gasoline station.

The commander server is connected e.g. via a RS232 connection to a Back-office controller 74. The Back-office BEN-POS controller 74 is monitoring and controlling the dispensers 36. Transaction data is transferred to the commander server 78 and then forwarded to the coordination center 82.

The gasoline dispensers can be e.g. “Nuovo Pignone” gasoline dispensers 36, which are controlled by the BEN-POS controller 74. The BEN-POS controller 74 can have a modular design and can simply be modified to operate most dispensers on the market.

The commander server 74 is also connected to a tank level measurement system. Automated tank gauging (ATG) systems provide extremely accurate wet stock control over multiple sites 24 hours a day, 7 days a week, allowing the site personnel to focus more on dry stock and sales, thus reducing the human error factor to the minimum. The tanks are provided with high-resolution tank probes 31 measuring fuel and water levels with ±0.5 mm accuracy (water: ±1 mm) in the −40° C. do +40° C. temperature range. A leakage sensor can monitor tank leakage. The high-resolution tank probe 31 measures fuel levels, water levels and fuel temperature in underground and above-ground storage tanks. The rod shaped probe 31 can measure different kinds of fuels, including gasoline, diesel, heating oil and aviation fuel. The probe 31 can be a solid-state construction that guarantees unmatched long-term stability and reliability, while providing high resolution and outstanding repeatability. A segmented, high-resolution probe, enables capacitive measurement without moving parts, allowing fuel level measurement, water level measurement, temperature measurement and dirt detection

The tank probes 31 in the tanks 30 are connected to a tank level gauge 76 supporting tank probes and SPR leakage sensors. The basic configuration may support up to 10 tank probes. It is envisaged to implement a module to provide connections for up to 10 active or passive leakage sensors or level switches. The responses of the tank probes 31 are constantly analyzed by an algorithm, for detecting dirt, possible measurement noise and other anomalies, which in conjunction with a segmented capacitive principle of the tank probes 31 can provide high accuracy of the measurements.

That is, the system of solid state probes 31 provides intrinsically safe power supply for tank probes, leakage sensors and level switches. The tank gauge 76 can provide a product height to product volume conversion in connection with temperature compensation, and can also provide a measurements history and product supply recording, and may even support alarm triggering.

The commander server 78 is an on-site controller that is specifically designed for local and remote gasoline station management, gasoline station monitoring and control. The commander server 78 integrates different measuring systems and control devices like automated tank gauges 76, fuel dispensers 36, POS (Point Of Sale) terminals 50 and payment systems 70 into a single system. Due to its modular design the commander server 78 can be adapted to any configuration of gasoline stations. It offers various solutions for POS and BOS BackOffice connectivity, enabling sales analysis, delivery variance analysis and, most importantly, business inventory reconciliation (BIR).

The commander server 78 can serve as a gasoline station controller, integrating gasoline station equipment and local and remote site management, monitoring and control. The commander server 78 enables central company-wide management of service stations and terminals. The commander server 78 can support common and proprietary data transfer protocols, and can transfer data over TCP/IP.

The commander server 78 can provide all necessary information for BIR, sales analysis and delivery variance analysis. The commander server 78 can also support third party manufacturer hardware and software. The commander server 78 can use alarm data and other data following e.g. IFSF (International Forecourt Standard Forum) standards.

The commander server 78 is especially designed for supporting tank level gauging equipment 76. The data gathered from the gauging equipment 76 is processed to provide quality information for inventory management, demand planning and supply chain management applications. Information is available in accordance with IFSF standards, including all required alarming levels. The data can reliably be stored until it is successfully transferred to other applications.

User management ensures traceability of every change in equipment setup as well as providing the basis for document management, including storing delivery and other approvals and shift-based inventory business reconciliation.

Commander server 78 has the ability to interconnect a large amount of devices, acting as a super-node for various gasoline station equipment and systems, allowing information exchange and providing remote access and management.

Local devices are connected to the commander server 78 using serial (RS 232 or e.g. RS 485) or LAN (Ethernet) connections. The CoCoS (Commander Component System) introduces modular design, based on services and drivers. The functionality is easily upgraded or changed by adding or changing individual components, customizing the commander server 78 to the customers' needs. New devices can be connected by simply adding new drivers.

Remote connections are established using modems or routers 80. Any wireless, dial-up or permanent connection can be used, as long as it supports the TCP/IP protocol. A powerful scheduler offers complete freedom and great flexibility when setting data transmission timetable. Alarm conditions are immediately sent, regardless of the scheduler. Every data transactions, especially alarms, must be confirmed as received by the remote computer, before being removed from the message queue. Local data duplication ensures maximal reliability of operation.

The commander server 78 is locally connected to:
tank gauging equipment 31, 76,
controllers and other devices 50 from various manufacturers,
fuel dispensers 36,
PLC industrial controllers and other devices,
payment devices 70, e.g. the M-payment device,
local computers (not depicted) monitoring fuel inventory and configuring/maintaining tank gauging equipment,
a gasoline station information system (a bidirectional information exchange, not depicted),
a gateway to a remote network (e.g. ISDN), typically a modem or a router 80.

The remote connections can provide a data transfer to the coordination center to exchange data with e.g. inventory servers, receiving/serving data from/to the commander server 78. A connection to a time server can be used to regularly adjust the system time of the commander server 78.

Connected remote computers can monitor the fuel inventory on-line and configure/maintain the tank gauging equipment, and clients can use remote serial ports.

The commander server gathers information from the measuring systems 31, 76, 74 and other gasoline station equipment 72 and provides different information to the users, including:
current fuel levels: fuel level, water/sediment level, fuel temperature and fuel volume, normalized fuel volume (at 15° C.) and time stamped last measurement,
filling detection,
alarming (IFSF compliant: Overfill status, Underfill status, Supply warning, High-High level alarm, High level alarm, Low-Low level alarm, Low level alarm, High water alarm, high sediment alarm), and
measurement history.

The operation of the controller server 78 can be managed directly (on-line) using Internet protocols (HTTP, FTP, CORBA in SOAP/XML), enabling local and remote information display, local and remote servicing and upgrading and local and remote system configuration.

FIG. 3 depicts a graph depicting the connection between the tank gauge signals and the transmission of a reorder signal. The commander server 78 can access reliable and accurate data for inventory management, representing a solid foundation for demand planning, dynamic inventory replenishment, inventory planning, transportation planning, delivery scheduling and delivery management.

The demand planning is visualized by the example of fuel stock planning. In the system manual overrides my always be performed, but are automatically tracked by the system that shows an information in plan/realization reports.

The goal is to optimize the cost of inventory (ownership costs, finance costs, risk costs, warehousing costs), while on the other hand minimizing stock-out costs. Demand planning dynamically ensures optimal safety levels by managing the demand, producing automatic inventory forecasts and placing automatically generated orders into the order management process.

The demand forecasts take into account numerous variables that affect the demand including seasonality, daily trends, weekly trends, price variations, holidays, even weather if relevant data can be obtained.

If the fuel lever falls below the reorder threshold, the commander server can send a signal to the coordination center to reorder an amount of fuel. The commander server can determine an averaged lead-time and a respective order quantity on the basis of order history data. At the point in time said order is transmitted the ordered amount may even exceed the actual fuel capacity of the tank. The commander server can be configured to optimize the order quantities, and shift the reorder limits, to achieve an optimized result.

FIG. 4 graphically visualizes the optimization problem of the coordination center. The main optimization target of the coordination center is delivery scheduling and transportation planning. Delivery and supply vehicle scheduling are the categories where the majority of oil & gas supply chain costs can be optimized. Sometimes even slight reduction of transportation costs can represent a significant value. The classic problem of trying to optimally fulfill the delivery requirements while optimizing transportation costs and matching the demand with the supply is not an easy one and has to be solved with strict transportation plans and accurate input data. The optimization problem is known as “the travelling salesman problem”.

Within the optimization problem it is required to define the supply chain network and resources (locations 20, . . . 27, suppliers 12, 14, terminals, transportation routes, supply vehicles 2, . . . , 10, compartments), various logistics constraints (carrier and supplier contracts, quantity windows, delivery windows, incompatibilities, preferred resources, holidays, etc.) and costs (not depicted). The planning strategy can be customized to meet optimal business goals, thus minimizing inventory costs and/or transportation costs.

The delivery-scheduling module optimizes the distribution plan, taking into account the demand forecasts, generated by the demand-planning module (e.g. the commander severs of the gasoline stations 20-27), currently available resources, in-process deliveries and business rules/logistics constraints deriving from the transportation planning model. The delivery-scheduling module schedules deliveries and optimizes product mix (truckload) for individual supply vehicles.

The system uses supply vehicles that can transfer the vehicle location to the coordination center enabling, for monitoring and communication via a communication system.

The communication system in the supply vehicles has been designed to meet the needs and demands of private, commercial, and fleet vehicle operators and even of government entities. The supply vehicles are provided with a positioning system to be able to keep track of the supply vehicles, optimize routes, support logistics and supply chain, ensure supply vehicle and driver safety and/or communicate with the driver.

The system can use GPRS technology to transfer the actual data making the system robust and allowing a pricing model that is suitable for a widespread field of users. The supply vehicles are provided with a navigational tool; however its main goal is not to instruct the driver, but to simplify fleet management, increasing driver and vehicle safety while reducing costs.

The basis of the system is a vehicle mounted mobile unit that continuously tracks the vehicle using e.g. GPS (Global Positioning System) and monitors the status of the vehicle (including the status of the payload). The vehicle data are transmitted to the coordination center e.g. via GPRS (GSM, TETRA) or any other means of communication and can be preset to link either continuously, on demand, alarm triggered, or periodically. In the coordination center the information is gathered, processed and stored. The users can then locally or remotely visualize the vehicles on digital maps, display vehicle status, monitor and control vehicle functions, communicate with the vehicle, generate reports and further analyze the data.

The system can track all vehicles, optimize the route/navigation of the vehicles, provide fleet management, support logistics and the supply chain, ensure vehicle and driver safety, communicate with the driver, perform remote vehicle diagnostics, and provide dynamic navigation

The supply vehicles with the positioning system and the communication system in connection with the coordination center enables transportation management with optimal route planning and navigation that effectively lowers transportation costs. Alternative communication paths further enhance driver to coordination center communication, enabling quick response times to unforeseen complications and/order changes as well as keeping high security levels of both the vehicle and the driver.

The supply vehicle with the information system is very usefully specially when many different drivers use the same vehicle. The system can be used to identify a driver (e.g. by keypad input) and evidence of who was driving the vehicle is managed in the coordination center. Also reports and expenses are managed via driver login. This system can be used as timeclock to record the actual working times to an extended working time and positioning management.

The supply vehicle also enables identifying a driver and keeping track of his different daily activities. When used properly the system gives an overview about the time spent on driving, on working with the client and on private matters. The driver can input via a keypad data about refilling fuel and transfer them to the coordination center, where the costs are managed. With a complex system with an improved payload detection probe this may also be transferred automatically.

It is also envisaged to enable voice calls like a normal mobile phone between driver and the coordination center and other numbers allowed by the coordination center (phonebook). There may also be provided a register of missed, dialed and received calls. It is possible to send and receive text messages via the communication devices of the supply vehicle. The driver can receive instructions, task descriptions and other information in a text form from the coordination center. Messages can be saved, so the driver can read them later and not while driving (it may also be envisaged to restrict the notification of a received message to a not driving condition of the supply vehicle).

One of the main functions of the coordination center is tracking the location of supply vehicles on digital maps. It enables an overview of last known locations, current location and tracking of vehicle movement in real-time. The coordination center supports an overview of rides, performed by a supply vehicle on a certain day or in a certain time interval. Simple selection of vehicles and objects, path details, time intervals, map scale and other setting enables a quick overview of the situation and the needed data.

The coordination center can use the vehicle location and other data in order to analyze individual trips in detail and determine efficiency of routes for every segment of the path. Next to basic criteria, e.g. speed of the vehicle and number of revolutions of the engine, the coordination center also uses vehicle load, road incline, road type and other criteria. An estimate, calculated by the coordination center, is a powerful tool that can be used by the vehicle fleet manager in order to supervise the usage of vehicles, thus substantially lowering the transportation costs. Based on data and analysis the coordination center prepares reports on journeys, vehicle usage and vehicle fleet management.

The coordination center and the communication enabled supply vehicles enable sending of short messages to supply vehicles, mobile units and to mobile phones. Messages can be sent to the vehicle or the mobile phone of the driver, individual groups or the whole vehicle fleet. All messages are stored and available for future overview.

This enables sending warnings about dangerous situations. An important function of the coordination center is providing warnings about unanticipated and dangerous situations to the supply vehicles. The center monitors alarms, triggered by the driver by pressing an SOS button, unauthorized vehicle movements, exceeding the speed limits and engine revolution limits, sorts them by priority and displays them to coordination center personnel. In this way, the user can take proper measures quickly and efficiently. The alarms are sent to user's phone or directly to a selected security company in form of e.g. short messages. All alarms are stored for future overview.

The system can use standard structures and protocols to enable a free data flow between the coordination center and the information system of the supply vehicle drivers of the users. Each piece of information, stored in the coordination center, can be exported to other applications adding location and status information to user's operations in real-time.

This application contains the description of implementations and embodiments of the present invention with the help of examples. It will be appreciated by a person skilled in the art that the present invention is not restricted to details of the embodiments presented above, and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

1. Method for operating a fuel distribution system having a coordination center, unmanned self-service gasoline stations with fuel reservoirs and gasoline supply vehicles, the method comprising the steps of:
periodically determining the available amounts of remaining fuel in the fuel reservoirs; determining the present positions and fuel levels of supply vehicles; and generating an optimized delivery path for each of said supply vehicles on the basis of said determined available amounts of remaining fuel in the fuel reservoirs, said present positions and said fuel levels of said supply vehicles.

2. Method according to claim 1, wherein said determining of the available amounts of fuel in the fuel reservoirs, further comprises:
periodically transferring said determined available amounts of fuel in the fuel reservoirs to said coordination center.

3. Method according to claim 1, further comprising periodically storing said periodically determined amounts.

4. Method according to claim 2, further comprising:
determining a user identification,
performing an authentication procedure,
dispensing fuel, and measuring the amount of dispensed fuel, and
transferring payment data to a payment center,
wherein said determined available amounts of fuel are transferred together with payment data.

5. Method according to claim 1, further comprising transferring said generated optimized delivery path to said supply vehicles.

6. Method according to claim 1, further comprising:
generating optimized delivery paths for all possible combinations of fuel levels of fuel reservoirs, supply vehicles fuel levels, the positions of the supply vehicles and fuel levels of said supply vehicles.

7. Method for operating an unmanned self-service gasoline station, comprising the steps of: periodically determining the available amount of remaining fuel in the fuel reservoirs; monitoring and controlling of gasoline dispensers;
performing payment procedures;
monitoring and controlling of fire protection and extinguishing equipment;
monitoring alarm sensors;
video monitoring;
remote equipment configuring; and
remote price pole configuring.

8. Computer program product comprising program code means stored on a computer readable medium for carrying out the method of anyone of claims 1 to 7 when said program product is run on a computer or network device.

9. Computer program product comprising program code, downloadable from a server for carrying out the method of anyone of claims 1 to 7 when said program product is run on a computer or network device.

10. Unmanned self-service gasoline station, comprising:
at least one fuel reservoir provided with a fuel gauge, said fuel reservoir being placed in a fuel-tight trough;
at least one fuel dispenser for each said fuel reservoir;
at least one platform for each fuel dispenser provided with a catch element and provided with oil traps,
at least one canopy element covering at least the area of each said platform and said trough,
said at least one fuel reservoir is an above-ground storage fuel reservoir;
all key components are modular and are provided with standardized connection elements and wherein said self-service gasoline station is further provided with
an automated tank gauging system, for said at least one fuel reservoir,
payment terminals for use with payment cards and mobile phones, operationally connected to said at least one fuel dispenser,
at least one remotely configurable price pole, and
a server operationally connected to said remotely configurable price pole, said payment terminals, said automated tank gauging system and said at least one fuel dispenser,
wherein said server is provided with a data exchange interface to a communication network for connecting it to a coordination center.

11. Unmanned self-service gasoline station according to claim 10, wherein said above-ground storage fuel reservoir is arranged in a concrete trough.

12. Unmanned self-service gasoline station according to claim 10, wherein said payment terminals for mobile phones are M-payment system payment terminals.

13. Unmanned self-service gasoline station according to claim 10, further comprising:
vending machines connected to said payment terminals enabling single payment operation for said fuel dispensers and said vending machines.

14. Unmanned self-service gasoline station according to claim 10, further comprising an automated fire extinguishing system and an automated fire alarm system.

15. Unmanned self-service gasoline station according to claim 10, wherein said at least one canopy element is provided with solar collectors for the operation of said gasoline station.

16. Unmanned self-service gasoline station according to claim 10, further being provided with an automated lavatory.

17. Unmanned self-service gasoline station according to claim 10 further comprising: a chassis connected to said fuel-tight trough and/or said fuel reservoir, wherein said refueling platforms and said canopy element are foldable.

18. Unmanned self-service gasoline station according to claim 10, wherein said automated tank gauging system comprises a probe for fuel level, water level, pollution and soiling detection measurement in said fuel reservoirs.

19. Unmanned self-service gasoline station according to claim 18, wherein said probe is a segmented, high-resolution, solid state based capacitive measurement probe, for fuel level measurement, water level measurement, temperature measurement and pollution and soiling detection in said fuel reservoirs.

20. Supply vehicle for an unmanned self-service gasoline station, comprising a tank section for at least one kind of fuel, characterized in that said supply vehicle is provided with a tank gauge, a positioning system and a communication device for communicating with a coordination center.

21. Supply vehicle according to claim 20, further comprising a vending machine goods container, floodlights, cleaning installation and lavatory maintenance devices.

22. Coordination center provided with a communication system for communicating with gasoline stations according to one of claims 10 to 19, supply vehicles according to one of claims 20 or 21 and fuel reservoirs.

23. Fuel distribution system with unmanned self-service gasoline stations according to one of claims 10 to 19 and fuel reservoirs, supply vehicles according to one of claims 20 or 21 and a coordination center according to claim 22.
